(19) United States
(12) Patent Application Publication
(10) Pub. No.: US 2013/0282608 A1
(43) Pub. Date: Oct. 24, 2013

(54) Engine, System and Method of Providing a Multi-Platform Payment and Information Exchange

(71) Applicants: Eric Raymond, Philadelphia, PA (US); Joshua Spivak, Philadelphia, PA (US)

(72) Inventors: Eric Raymond, Philadelphia, PA (US); Joshua Spivak, Philadelphia, PA (US)

(21) Appl. No.: 13/920,818

(22) Filed: Jun. 18, 2013

Related U.S. Application Data
(63) Continuation-in-part of application No. 13/839,296, filed on Mar. 15, 2013.
(60) Provisional application No. 61/619,654, filed on Apr. 3, 2012.
(60) Provisional application No. 61/775,484, filed on Mar. 8, 2013.

(51) Int. Cl. G06Q 10/10

(52) U.S. Cl. CPC G06Q 10/1057
USPC 705/322

(57) ABSTRACT

System and method for managing insureds' benefits information, comprising a “benefits vault” database that stores data of insured parties, their respective benefit choices, financial contributions to the vault, and restrictions on the use of the contributions, a rules engine that associates the benefit choices with the respective insureds in accordance with predetermined criteria, a remote benefits engine that accesses remote third party resources to implement the benefit choices, and a reporting engine that provides confirmation of the implementation.

This application is a continuation in part of U.S. patent application Ser. No. 13/839,296 filed Mar. 15, 2013 entitled ENGINE, SYSTEM AND METHOD OF PROVIDING A MULTI-PLATFORM PAYMENT AND INFORMATION EXCHANGE; and takes priority from U.S. Provisional Patent Application Ser. No. 61/619,654 filed Apr. 3, 2012, entitled ENGINE, SYSTEM AND METHOD OF PROVIDING NORMALIZED, MULTI-PLATFORM INFORMATION; U.S. Provisional Patent Application Ser. No. 61/775,484 filed Mar. 8, 2013, entitled ENGINE, SYSTEM AND METHOD OF PROVIDING NORMALIZED, MULTI-PLATFORM INFORMATION, the entireties of which are hereby incorporated by reference as if fully set forth herein.

### FIELD OF THE INVENTION

The present invention relates to data normalization and financial transactions in relation to information access and sharing across platforms, and, more particularly, to an engine, system and method of providing a multi-platform information and payment exchange and infrastructure.

### BACKGROUND

Processing of a company's payroll includes both pre and post tax “payroll deductions”, typically performed by an automated system. Although standalone payroll systems facilitate the automation of certain of these steps, there remains a significant “pooling of assets” in the process. More specifically, once requested payroll deductions are made, the employer is responsible for managing those funds and for applying those funds by “category/policy.” This must be done in a timely manner to avoid liabilities for the employer. For example, deductions taken for a voluntary life insurance policy are withheld via a so-called “single/dedicated deduction slot,” and when applied to the policy, the employer must undertake verification of the coverage amount, beneficiaries, and suitability of the deduction based on the age of the employee and the coverage desired. Deductions may also include tax consequences, such as ensuring proper pre-tax and post-tax deductions, proper administration of cafeteria programs such as flexible spending accounts (FSAs), healthcare premiums, and retirement savings account payments such as 401 K payments, for example.

Commonly, the monies deducted from employee paychecks are pooled in a single employer-controlled account. Payments from such an account and adjustments made in the actual deduction of employee funds are typically performed manually within a company, or are delegated to an outside payroll service to ease the administrative burden on the employer and to relieve the employer of the duties and potential liabilities that attend the administration. Keeping track of the legal payment and reporting requirements across federal, state and local tax authorities, and complying with the many employment-related laws, is a complex task for which most companies are ill-suited. The process is not only difficult and time consuming, but often results in errors, which ultimately may cause the company to incur significant liability in the form of back payments and penalties, as well as substantial expenditures of time and money to determine the cause of and resolve such errors.

Moreover, deductions and other adjustments made to an employee's compensation are generally outside the control of the employee, because much of the information regarding payments made on the employee's behalf may not be communicated to the employee. For example, not only must a company take manual steps to transfer employee information to a payroll service, but any subsequent changes made to employee data, such as a timesheet adjustment, added bonus, etc., may necessitate repeating the payment processes to generate correct processing data. In some cases, to avoid missing a payroll a company may delay certain changes until the next payroll, requiring further modifications to the payroll system data.

Large companies, in particular, have attempted to get the “best of both worlds” by adopting a hybrid approach, using a standalone payroll system to calculate payroll-related data, and then manually transferring summary payroll data to an outside payroll service. One problem with this approach, however, is that payroll services generally require summary data in a particular format, which is not necessarily compatible with the output generated by a company's standalone payroll system, which may be designed to enable the company to act as its own in-house payroll service. As a result, companies may need to devote resources to interfacing these two incompatible systems.

It is inefficient for most companies to set up the infrastructure necessary to handle the tasks described above. A comprehensive and intuitive system could implement an infrastructure to facilitate employment-related laws and payment and reporting requirements to federal, state and local tax authorities for numerous companies on a nationwide, or even worldwide, basis, and would further allow for processing of other payments. Such a system may automate the disbursement of funds, and the generation and transfer of information necessary to meet various reporting requirements, and to inform employees of payments made and the particulars of deductions and/or adjustments to their compensation, such as an explanation of the services being purchased or investments being made.

Further, existing payroll systems and payroll services, including those discussed above, have not adequately integrated employee benefits into the payroll process itself. For example, certain medical benefits result in both pre-tax and post-tax deductions. Although existing payroll systems permit such deductions to be entered, they do not enable companies to set up custom policies pursuant to which the system will calculate automatically, for each pay period, the appropriate pre-tax and post-tax amounts for all employees and/or contractors. Moreover, existing payroll services do not typically manage employer disbursements to medical service providers, life insurance providers, and other benefit providers. Therefore, companies are required to manage such payments, and generate and transfer associated information and reports, themselves.

Existing payroll systems and payroll services may not enforce and/or comply with the various employment-related, security-related, and tax-related laws, rules, and guidelines governing incoming monies and outgoing payment processes. For example, many such systems and services would permit an employee to include a $2000/month paycheck deduction over an entire year for a 401(k) plan on a pre-tax basis, despite the much lower current annual pre-tax deduction limit on such plans. Further, the rules governing 401(k) deductions are projected to annually increase the yearly allowed deductions, requiring annual updates to the system that implements the deductions.

Existing payroll systems and services also do not enable employees to designate miscellaneous payees for payments from various accounts, including payroll deductions, such as out-of-pocket medical expenses, mortgage payments, third party (i.e., non-employer selected) insurance payments, child-care payments, etc. As such, each employee must expend her own time and effort over and above that expended by the employer or service provider, in tracking and making payments that are exceedingly common among households. Individual self management by each employee may increase the likelihood of missed payments, which detrimentally affects the payee in each such transaction, and which may also adversely affect the employer, for example, due to employee aggravation because of missing payments and/or collection agency calls, etc.

Moreover, existing payroll and global account access systems do not account for existing and upcoming legal changes. For example, under the new healthcare law (Patient Protection and Affordable Care Act (PPACA) or “Obamacare”), employers, employees, and independent users of healthcare must modify their prior practices regarding how they provide and obtain healthcare and other insurance benefits. In the near-term, important changes in the applicable statutory and regulatory requirements include changing the purchase of healthcare related services from a group basis to an individual basis; and changing insurance coverage from an employer-based model with an employee contribution, or so-called group insurance, to an employee-based model with an employer contribution, or a so-called “defined contribution” plan or “benefit bank”. In defined contribution plans, user access must be provided to a health insurance exchange (HIX). An HIX is a market of government-regulated and standardized health care plans, which may be public (e.g., a state or federal exchange) or private, from which individuals may purchase health insurance that is eligible for federal subsidies under PPACA.

No infrastructure is available for an employee to arrange his/her own individual health insurance and set aside money via payroll deduction or the like for his/her contributions in consideration of at least the PPACA. Instead, insurance premiums are typically still split between the employer and the employee, with the employee's portion withheld in equal amounts by payroll deduction in each pay period. For example, consider an illustrative group-based program with a $1,000 monthly premium where an employee is responsible for half, or $500. The employee's $500 monthly contribution is typically withheld from his/her compensation, typically spread out over a year in equal amounts per pay period via payroll deductions. Premium payments are typically made directly by the employer to the insurance company for all employees insured under a plan. However, under the PPACA the employee will be responsible for ensuring that the premium for his/her own individually selected insurance is paid. Heretofore, there has been no system in place to satisfy this requirements of the PPACA, that enables employees to continue to pay their premiums using convenient payroll deductions.

In addition, individuals may purchase health insurance and services under the PPACA in public and/or private exchanges. This provision causes additional complexities to arise with regard to how insurance bought via an exchange is funded by the insured. The PPACA provides: 1) a subsidy from the government for residents making less than 400% of the federally defined poverty level. This accounts for approximately 70% of the US population. 2) Employer contributions are to be made via grossed up wages or defined contributions. 3) The insured's contribution is the difference between the cost of the insurance plan selected by the employee, and the combined amount of an employer contribution, if any, and a government subsidy, if any. For example, suppose an employee selects a family health coverage plan in which the premiums are $1000/month. If the employee qualifies for a $400/month federal subsidy, and the employer provides a benefit contribution of $300/month, then the employee's contribution will be the difference between the cost ($1000) and the combined subsidy and employer contribution ($400+$300=$700), which is $300 ($1000−$700=$300). Actually implementing and documenting such calculations and monetary transactions may be cumbersome and prone to errors.

The requirements of the Health Insurance Portability and Accountability Act of 1996 (HIPPA) also come into play. HIPPA requires an individual's healthcare information to be maintained in confidence. Accordingly, to ensure privacy of medical information an employer may not be permitted to have knowledge of benefits chosen, and/or healthcare services actually obtained, by an employee. Therefore, a mechanism is needed that will enable the employer to confirm the qualification of healthcare expenses under applicable programs without the employer having to contact the healthcare provider directly, thereby violating HIPAA. Consequently, such activities may need to be outsourced.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods; and

FIG. 3 is an illustration of aspects of the present invention;

FIG. 4 is an illustration of aspects of the present invention;

FIG. 5 is an illustration of aspects of the present invention;

FIG. 6 is an illustration of aspects of the present invention;

FIG. 7 is an illustration of aspects of the present invention;

FIG. 8 is an illustration of aspects of the present invention; and

FIGS. 9A and B is an illustration of aspects of the present invention.

### DETAILED DESCRIPTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art.

The herein disclosed systems and methods provide an online payroll, account management, global payment, deduction and benefits system that gives employees real-time access to, and notification of, programs that are available to respective employees, and payments made on behalf of the employees. Further, both employees and employers benefited by automated rules and alerts that provide improved flexibility and control over prior art practices, as well as the convenience of seamless lines of communication to third party services, such as payroll services, insurance services, banking services, medical services, mortgage payment services, etc. Yet further, employees and employers are provided with tools to account for many commonly incurred expenses, and to document compliance with applicable laws, rules, and guidelines.

Thus, the herein disclosed systems and methods provide an open, real-time benefits and accounts management and payment platform, to provide for the management of payroll deductions, global payments, and to provide for real-time reporting and adjustments based on employee and/or payee choices.

A computer-implemented platform, system, and methods are disclosed for facilitating benefits and payment processing. Described embodiments are intended to be exemplary and not limiting. As such, it is contemplated that the herein described systems and methods may be adapted to provide many types of users with access and delivery of many types of services, and can be extended to provide enhancements and/or additions to the exemplary services described. The disclosed systems and methods are intended to encompass all such extensions, the protected scope of which are defined by the appended claims.

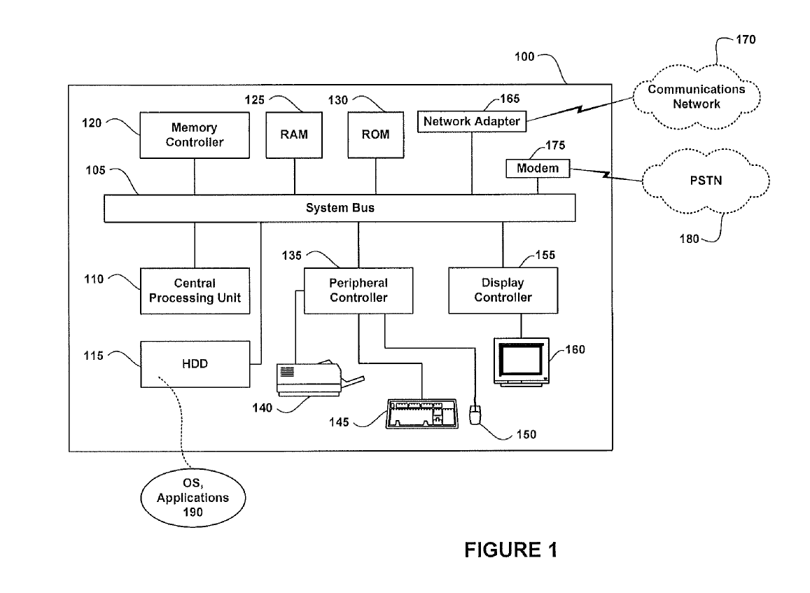

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

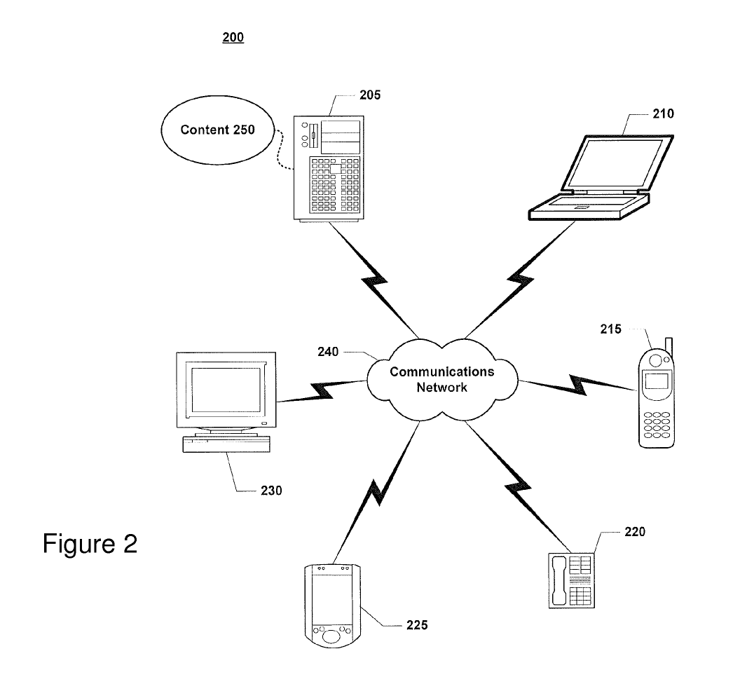

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example. Some operating systems may or may not allow for the use of a proxy server and some may or may not have encryption. Of course, because many of the aforementioned operating systems are proprietary, in prior art embodiments server 205 delivered to client device 225 only those applications and that content applicable to the operating system and platform communication relevant to that client device 225 type.

Of note, well-known payroll services from ADP (Automatic Data Processing, Inc.) of Roseland, N.J. (ww.adp.com), Paychex, Inc. of Rochester, N.Y. (www.paychex.com), and PayMaxx, Inc. of Franklin, Tenn. (www.paymaxx.com) all provide computerized, networked capabilities that enable companies to outsource the calculations necessary to generate employee paychecks and employer/employee tax liabilities, and to make scheduled tax filings and payments to the relevant tax authorities. Such companies, however, generally require summary information for each pay period (including income, overtime, bonuses, commissions, pre-tax and post-tax deductions, etc.) and that the employer provide such information to the payroll service in a specified format, and do not provide the more generalized functionality envisioned in the present invention.

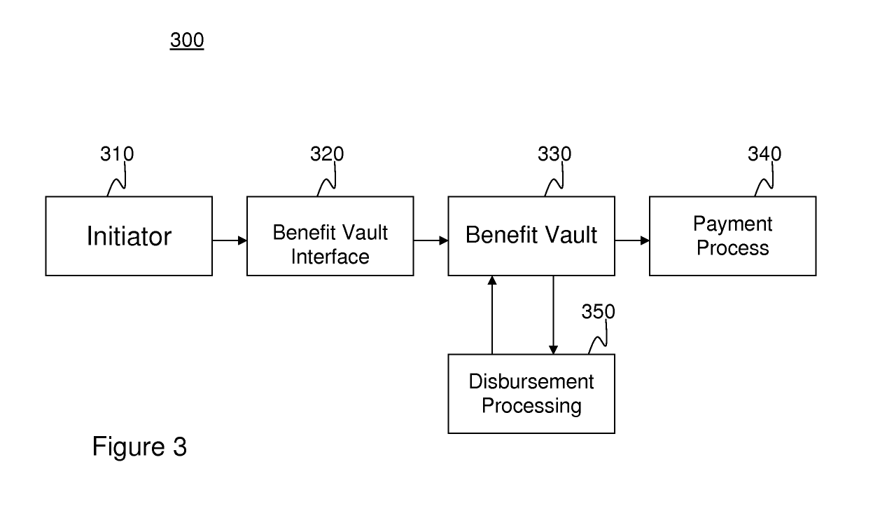

FIG. 3 shows an exemplary payment and disbursement system according to an exemplary embodiment. System 300 includes initiator 310, interface 320 to a benefits database 330 (“benefits vault”) containing benefit information, payment processor 340, and disbursement processor 350. Initiator 310, which may be an employee seeking to initiate a permissive payment and disbursement or an employee subject to a mandatory payment and disbursement, transacts with benefits vault interface 320, which may be operated by an entity other than an employer. Benefits vault interface 320 may receive payment and disbursement information from initiator 310, and benefits vault interface 320 may record the information in a database and transmit the information to benefits vault 330. Benefits vault 330 may verify and process the payment and disbursement information. For payment processing, benefits vault 330 may transmit payment instructions according to payment processor 340. Payment processor 340 may incorporate financial processing information. For disbursement processing, benefits vault 330 may transmit disbursement information to disbursement processor 350. Disbursement processor 350 may incorporate non-financial information.

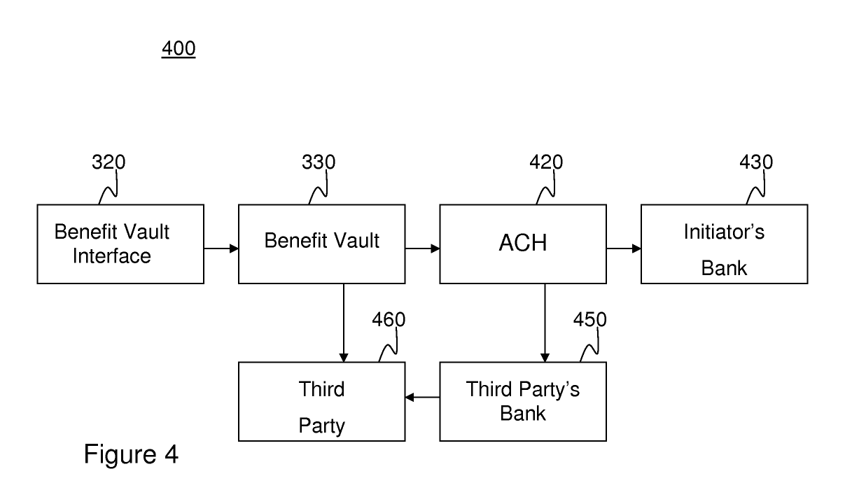

FIG. 4 illustrates an embodiment of a payment processing system consistent with system 300 shown in FIG. 3. As shown in FIG. 4, payment processing system 400 includes benefits vault interface 320, benefits vault 330, automated clearing house (ACH) 420, initiator's bank 430, third party's bank 440, and third party 460. As shown in FIG. 3, benefits vault interface 320 may receive payment and disbursement information, may record the information in a database, and then may transmit the information to benefits vault 330. The transmission of this information may occur in the form of an addendum-based financial electronic data interchange (FEDI) file. Electronic data interchange (EDI) describes the computer to computer exchange of information from one entity to another using electronic communication, and electronic funds transfer (EFT) describes the exchange of an electronic payment using electronic communication. FEDI is a combination of an EDI disbursement information with an EFT electronic payment. Benefits vault 330 may receive a FEDI file, verify the validity of the information in the file, and then record the information in a database. Following validation of a FEDI file, benefits vault 330 may segregate the payment information and the disbursement information from the FEDI file. Benefits vault 330 may then send payment information to payment processing 340 and the disbursement information to disbursement processing 350. For the processing of a payment according to FIG. 4, benefits vault 330 may transmit an EDI addendum to third party 460, with data indicating that a payment has been made.

ACH 440 serves as a clearing house for processing financial transactions through the Federal Reserve system, such as, for example, the National Automated Clearinghouse Association (NACHA). Following transmission of the payment information to ACH 420, ACH 420 may then process the transactions initiated by benefits vault 330. Because transactions may be debit-based transactions, ACH 420 may perform two transactions. First, ACH 420 may issue a debit against the payor of the payment, and second, ACH 420 may issue a credit to the recipient of the transaction. Thus, for debit-based transactions initiated by benefits vault 330, ACH 420 may initiate a debit transaction to the initiator's bank 430 and a credit transaction to a third party's bank 440. Again, ACH 520 may utilize various EFT formats for multiple transmissions of these electronic transactions. Once ACH 420 has completed these transactions, payment processing has occurred, as third party 460 has received payment in third party's bank 440 from initiator 310 through benefits vault interface 320.

In an embodiment of the present invention, payroll deductions may take the form of cash, direct deposit, check, debit card, “pre-paid” card, or other instrument having value. Such deductions may take the form of taxes, benefits (both pre and post tax), etc. Additional deductions may include pooled account and/or individual accounts. For example, a $98 per week deduction may be applied to one or more of life insurance, health care, car insurance, homeowners insurance, child care, an investment account, and/or FSA. The herein disclosed systems and methods may configure data/premium spreads and respond to the benefits vault, providing for an information repository and management tool that provides information, for example, for use in banking transactions (inflows and outflows, claims, supplemental coverage, etc.), employee access to information, employee transparency (e.g., personalized website), a location for payments (“sub wallets”), data delivery (employer, employee, carrier of products), and marketing to consumers (ad delivery). Information from the benefits vault may be delivered in real time to various sources, such as third party systems, in any format known to those skilled in the art.

For example, an employee may make benefits choices, such as by signing electronic forms, to designate deductions. Then, rather than simply being able to see deductions on payroll slip, the employee may log into a web site using a computer or smart phone application to see the deductions and relevant information regarding the deductions. The paystub delivered to the employee, which may be electronic or paper, may thus include only a single composite deduction. For example, funds to pay insurance costs may go into employee's “own” benefit bank.

The herein disclosed systems and methods may accordingly decrease an employer's back office administration in applying premiums and data to identified insurance policies. For example, the system may provide data delivery in a format needed by an insurer so that the insurer can accurately apply payments to the appropriate policies.

More particularly, and in view of the foregoing aspects, the herein disclosed systems and methods may use a stored value card (SVC). The stored value card maybe a Visa or MasterCard, or other bank card, for example. Third party payments may also be made using the stored value card, such as deductions of $100 into three different policies of $33.33 each, for example. In this way, payroll companies may converge payment services with benefits to be paid to employees. Such productions may include insurance payments, healthcare payments, and savings deductions, for example.

The herein disclosed systems and methods may provide a personalized vault, or virtual wallet, to carry out the aforementioned and the following functionality, and may also interface with other computer-based platforms, such as Google's health and virtual wallet, for example, thereby allowing for more efficient use of such platforms. In addition to adding the practical use of a stored value card, physical cash delivery may be provided via an automated teller machine (ATM) linked to a participant's account. In an exemplary operation, Google's virtual wallet and/or the benefits vault may allow an employee and/or employer to credit or debit a certain amount to/from the card, such as to pay for non-employer offered insurance, for example.

From an employer perspective, invoices may be matched and data entered into employer owned service systems, and data may be aligned to more efficiently track employee pay and handle reporting requirements that may be necessary by the employer state and/or federal reporting. The employer may also pay insurers via the individual bank account (VBA), and may use such an account as a preferred way of paying for certain items.

In an embodiment, the individualized virtual wallets may also provide “shelves,” and/or drop downs, for which data layers within the account may be viewed by a user, for example. Such spreads and respreads of information may not be done at the employer, but may be done by the present invention remotely and may be accessible to the user for whom the virtual wallet is attributed.

In addition to a dedicated virtual wallet and/or user specific accounts, a separate supplemental account may be retained by the employer. Such a supplemental account may allow for an employer to withhold certain monies owed to an employee, and pay them with accuracy via the present invention to a third-party. For example, such payments may include life insurance payments, such as to avoid frequent issues where large companies often hold money from the employee but fail to pay it to a third-party and sure in a timely manner.

In an environment of the herein disclosed systems and methods, the virtual wallet and/or a supplemental account may be, in part, contained in the aforementioned vault of the present invention, which may be accessed remotely by an employee and or an employer. Such access may be done by using a smartphone, for example. As discussed above, “shelves” allow each entity to be targeted and access the information allotted to them.

The card of the herein disclosed systems and methods may allow for the storing of profile information including, for example, benefits information, job change information, income of the user, and other like attributes. Such information may allow for specific and direct advertising to the users of the present invention. The present invention may also include medical information and may track the use and spending habits of the user of the card. The card may also have the ability to maintain and collect and control access to electronic medical records (EMRs).

By way of example, forty percent of compensation may leave a group, and the money may be given as a reimbursement for individual insurance in subsequent years. Advertising revenue may be generated when people go to through third-party sites, such as, for example, fidelity.com, through an ad.

The present invention may also be branded for third parties such as insurance companies, such as, by way of further example, State Farm, which may allow for payroll deductions to be used as payment for services, thus making the transfer of money from the employee to the insurance company, State Farm, much more efficient. Further, continuing with the present example, State Farm may allow consumers to budget and pay for services in various ways through the use of their cards, such as, for example, allowing for payment plans tailored to each individual user. State Farm may also collect information about the individual and may also facilitate advertisements to the user herself.

The present invention may allow employers to save money processing payments to employees, and may allow employers who may not otherwise have been able to offer certain benefits to employees through the use of the card. Furthermore, third party service providers may get paid more quickly and provide better access to the insured. Similarly, consumers and/or employees obtain more efficient transactions using the card of the present invention and may have greater transparency with the payments by the employee and the payments made by the employee to certain third parties, which may include, for example, insurance, savings, and health care expenses. Furthermore, administrators may access and obtain information about each user, while other service providers not connected initially with the user may be alerted when there is a change with the employee, such as, for example, a change of employment, and/or geographic living area.

As would be known to those skilled in the art, the card of the present invention may utilize near field communications for payment options, HRAs, SRAs, and flexible benefits, for example. Each employer or employee may create an actual bank account of their choosing. In this way, the present invention may be used with any third-party bank and maybe used with a bank associated with the employer or the present invention. In any case, and administrator or agent of the present invention may administer any and all user accounts assigned to the agent and/or employer regardless of the bank account affiliation used by the end-user.

Complying with legal requirements of providing healthcare has long been a complicated endeavor, requiring significant resources to implement and verify. That endeavor has been made profoundly more difficult by passage of the Patient Protection and Affordable Care Act (hereinafter PPACA, or “the Act”), a federal statute signed into law on Mar. 23, 2010. It represents the most significant government expansion and regulatory overhaul of the U.S. healthcare system in over 50 years, and has been deemed by some observers to be of the most complex government programs ever conceived. The PPACA is divided into ten titles containing a plethora of provisions, some of which became effective upon enactment, some 90 days after enactment, some six months after enactment, and others being phased in through 2020. Complicating matters even further, in some cases the PPACA works in cooperation with provisions of other statutes such as the Health Care and Education Reconciliation Act of 2010. Healthcare system stakeholders include not only healthcare providers and the insured, but large and small businesses, insurance providers, pharmacies, federal and state government agencies and programs, and even educational institutions, chain restaurants, and somewhat surprisingly, individuals that remain uninsured. The mechanisms it reaches in order to influence the delivery of healthcare include the establishment and operation of credit facilities, the use and administration of flexible spending accounts, health reimbursement accounts, and health savings accounts, insurance rate implementation, tax consequences, and many, many others. Determination of the provisions that affect any particular stakeholder, and implementation of and compliance with those provisions, is likely to be exceedingly difficult. Further, lack of compliance may incur adverse consequences such as penalties and fines.

Thus, under the new healthcare law (Patient Protection and Affordable Care Act (PPACA) or “Obamacare”), employers, employees, and independent users of healthcare are going to be rethinking and restructuring how they provide and obtain healthcare and other insurance benefits. There are many issues to consider and there will be a number of experts standing by to assist and guide. The two biggest changes that will occur are: change from group based purchasing, to individual based purchasing of healthcare; and change from employers offering insurance coverage with an employee contribution, to offering an employer contribution and providing access to a public or private exchange to purchase healthcare—known in industry as a “defined contribution” or benefit bank.

This causes several issues for both the employer and the insured: There is no infrastructure set up for an employee to set aside money via payroll deduction for his/her contribution towards healthcare premiums using individual policies. Previously, insurance premiums were split between the employer and the employee, with the employee's portion withheld in equal amounts by payroll deduction. For example, in a group based program with a $1,000 monthly premium where an employee is responsible for half, the employee's $500 is spread out in equal payroll deductions, and premium payments are made directly from the employer to the insurance company. There is no similar system under PPACA that allows employees to pay their premiums using payroll deductions. PPACA brings additional complexities to how insurance bought via the exchange is funded by the insured: 1) there is a subsidy from the government for residents making under 400% of the federal poverty level, which accounts for approximately 70% of the US population; 2) employer contributions via grossed up wages or defined contribution; 3) the insured's contribution is the difference between the employer contribution and government subsidy, if any. HIPPA also comes into play whereby the employer cannot help the employee, or have knowledge of the benefits chosen, etc. Instead, those activities need to be outsourced.

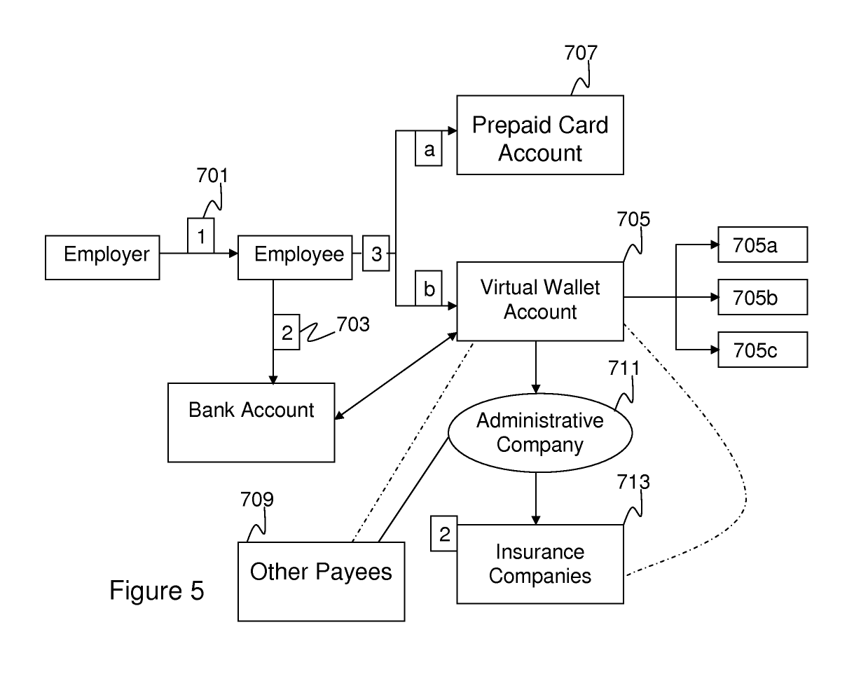

In exemplary embodiments of the vault of the present invention, and in order to address the foregoing issues, including the PPACA, the present system and method may receive monies, for example, as paid in or otherwise available to a secure, dedicated, virtual wallet account, also referred to as or included in the “vault” as discussed hereinthroughout. Such paid in or available monies may include, but are not limited to, monies paid in the form of payroll deposits, monies available from bank accounts, or the like, as shown, in part, in FIG. 5 (at steps 701 and 703). Of course, monies paid for payroll into the dedicated account may pass through a payroll processing center, may include an EFT to a back account, or the like. Other accessible paid or available monies may include, by way of non-limiting example, one or more of credit card accounts, available loans or lines of credit, Google Wallet accounts, Paypal accounts, or the like, and may be paid into the vault with or without the use of an administrator such as the payroll processor referenced above.

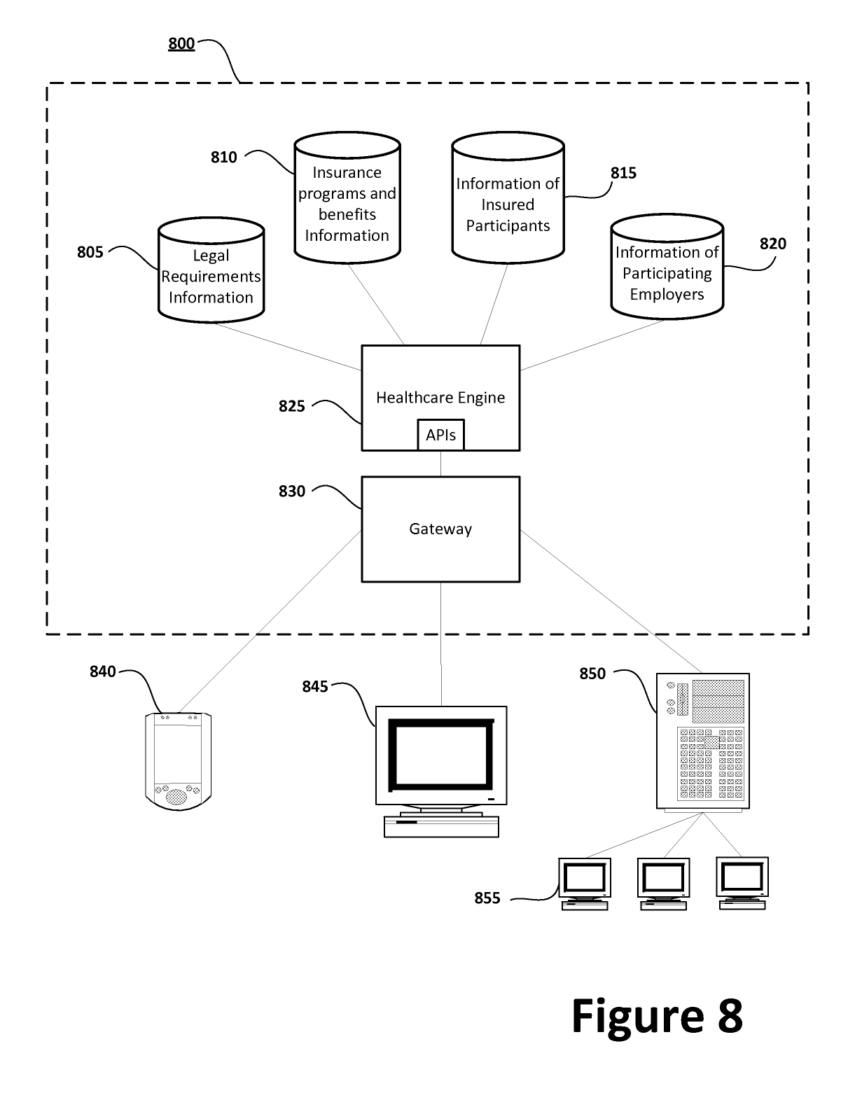

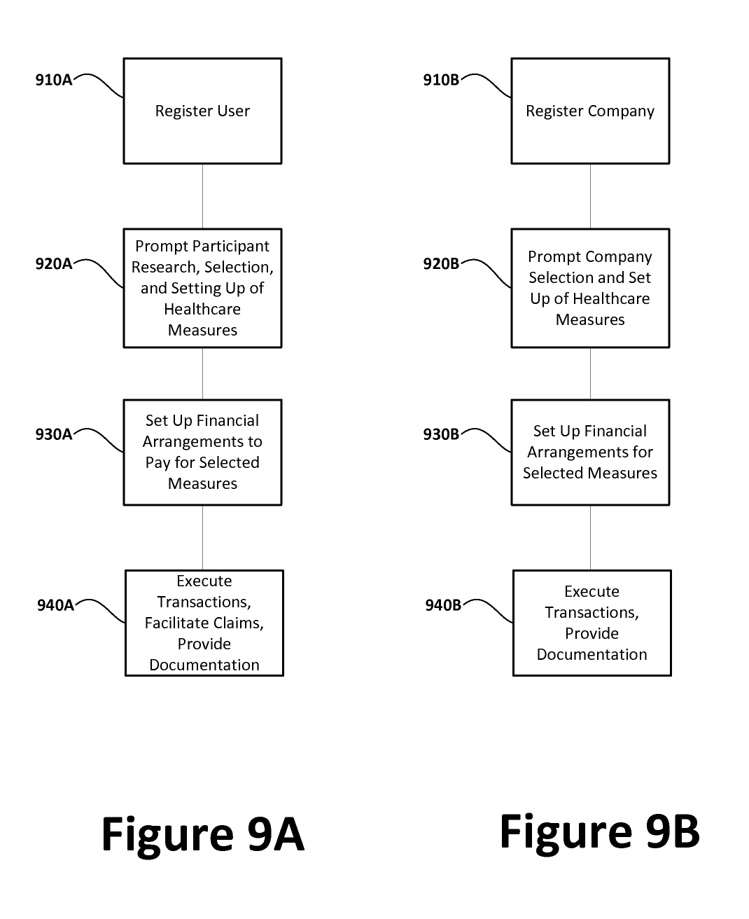

Such monies may be accessible to the aforementioned dedicated account 705, such as based on indication from the user, or based on an authorization or acquiscence by the user, an employer, a credit card entity, a bank, a payroll processor, or the like, for making payments. Such payments may be made, for example, to a prepaid card account 707 (such as a so-called “flex spending account”), or to payees 709 for goods or services, online or offline, and through or not through an administrative entity 711. For example, a user may pay utility bills, credit card bills, online purchases or auctions, or healthcare and other insurance 713. Those skilled in the art will appreciate that the healthcare payments in particular may be administrated as discussed herein, at least with respect to FIGS. 8-9, due to statutory and other restrictions.

Payments may be made via EFT, online login to a third party website or other secure site, or via issuance of a physical check, such as may be printed on a local printer by the user, or such as may be issued by a third party payment processor and automatically sent to the respective payee. Further, payments may be individually approved by the holder of the vault account manually and on a case-by-case basis, or may be made automatically, such as in the form of recurring payments stemming from a single indication by the vault account holder.

More particularly, the disclosed systems and methods may disburse monies to any authorized location, and in any format, from a vault. For example, disbursements may occur in the form of cash withdrawals from an ATM, or by electronic transfers of account credits, such as to pay health insurance premiums, home or auto insurance premiums, or other qualifying payments under the PPACA. The aforementioned payments to a card may include, for example, a debit card, such as a Visa or Mastercard branded card, that may be used like a credit card to pay for healthcare-related products and services. In embodiments, the system may interface, such as via an API, to a payment administrator in the form of an Automated Clearing House (ACH). An ACH is an electronic network for financial transactions that processes large volumes of credit and debit transactions. ACH credit transfers may include accepting direct deposit of payroll monies. ACH direct debit transfers for the insured may include payments to vendors and the like, such as payments to insurance providers for insurance premiums, payments to healthcare service providers for services received, payments to pharmacies and medical supplies vendors for qualifying drugs and equipment, and the like.

Moreover, payments may be made from a single accessible or paid in monies location, such as from a single checking account or a particular credit card account, or may be made from combinations of accessible monies. For example, healthcare payments may be paid in percentages from various locations, such as 50% from a monthly payroll income, 25% from a particular credit card account, and 25% from a savings account.

In the foregoing embodiments, and whether a payment due is paid entirely from one location or is paid in percentages from several locations, payments may be apportioned in advance, whether or not such payments are to be made automatically. As such, the present system and methods may provide none, one or many “vault trust” accounts, in which monies may be moved from a monies available account to the vault trust account for dedicated use of those moved monies at a later time. Thus, by way of non-limiting example, a user may set up a series of vault trust accounts 705a, 705b, 705c within the user vault, each with a purpose assigned by the user (or by the provider of the money, such as may be the case with an employer paying an employee), and thus each with a particular payee, a payment time, a payment amount, or a payment location or locations from which monies are to be drawn to make a payment, as may be indicated by the vault account holder, or as may be indicated by the administrator of the payment, if applicable (such as an employer if the employer maintains control over certain uses of a payroll payment, i.e., 5% of the employee's monthly pay is to be dedicated to healthcare insurance, or 2.5% of the employee's monthly pay is to be held for payment of non-resident taxes to the state of California).

Yet further, as referenced above, trust account payments may be made automatically as indicated (and, due to status as a trust account, only as indicated), or may require an agreement from the vault account holder or particular trust account administrator to execute payment. In embodiments requiring the latter, the party who must agree to payment may receive a reminder, either in the present application, such as via the GUI thereof, or via a communication instructed by the present systems and methods. Such information, reminders, or indications that are instructed by the presently disclosed systems and method may include, for example, auto-generated/populated emails, text alerts, social networking alerts, calendar reminders, and the like.

Of course, those skilled in the pertinent arts will appreciate, in light of the discussion herein, that the trust accounts may be set up within the vault by the vault account holder, or by an administrator with the power to control certain monies of the vault account holder, or may constitute default, or recommended, trust accounts. For example, the system and methods disclosed may allow for the secure and anonymous tracking of frequently created and/or used trust accounts. In light of this information, trust accounts may be suggested to a new user, or default trust accounts may be autopopulated into a new vault account. Of course, the vault account holder may or may not agree to and/or maintain default or suggested trust accounts.

It will be readily understood, in light of the foregoing, that incoming available monies may also be apportioned, either by a vault account holder or by an administrator. For example, incoming payroll monies may be apportioned, in part, to payment of a series of bills (i.e., cable, utilities, telecommunications) that may be paid automatically each month, in part to a savings account of the user, in part to a checking account of the user, in part to a credit card bill of the user, and in part to a healthcare trust account of the user. The healthcare monies may be held for 10 days after the payroll income, at which time a predetermined amount, such as $1200, may be directed to be paid to an insurance administrator or insurance company.

As such, the system may allow a vault account holder to be subjected to payroll deductions, such as by interfacing via an API with a participant's employer's payroll department or provider, and such as by withdraw automatically from a dedicated trust account for each deduction. That is, the payroll department may not have access to any other aspects, any other payments, or any other income of an employee, other than the specific, dedicated and secure payroll deduction trust accounts to which that employer is authorized access.

In embodiments, the use of third party contributed funds may be limited to certain uses designated by the contributing party, such as an employer. For example, an employer may contribute pre- or post-tax funds to an employee's vault and impose restrictions that limit the use of the funds to preapproved purposes. Such purposes may be determined by the tax code, such as if the contribution represents pre-tax money that is limited by the tax code to specific uses. Further, the employer may define restrictions in connection with the use of employer contributions, similar to a flexible spending account. For example, the employer can contribute funds to an employee's vault with attached conditions. Such conditions can include any desired restrictions, either restricting the funds to certain uses (e.g., insurance costs), or restricting the funds from certain uses (e.g., forbidding use of the funds for entertainment-related expenses, liquor purchases, etc.).

Illustratively, funds may be dispensed through the use of a card mechanism that may provide access to one or more of a credit balance, a gift balance, an FSA balance, or may be used as a credit card to extend credit. An employer may contribute funds to an FSA, for example, and impose restrictions on the use of those funds for specific designated benefits, or for spending with certain entities such as an employer preferred insurance provider. As such, the employer contribution may be regarded as an optional benefit, i.e., the employee is not required to use the employer preferred insurance provider (e.g., Blue Cross/Blue Shield), but the employer contribution may only be applied to that provider. Similarly, an insurance company may provide an optional contribution to an individual account as an incentive to the individual to select an offering of the contributing insurance company. Likewise, any vendor may provide such an optional contribution to an individual's vault as an incentive for the individual to make a purchase from the vendor.

Such restrictions are not limited to employer contributions, nor to vendor contributions. Rather, limitations may be imposed and enforced in connection with any contribution to an individual's vault made by any party. For example, a family member or friend may make a contribution as a gift to an individual, with limitations imposed on the use of the contributed funds. Such limitations may be arbitrarily specific, and have any desired scope.

Further, the herein discussed systems and methods may be arranged to enable individuals' accounts to receive government subsidies, such as via an API to a government facility, and may deposit the subsidies into the appropriate participant accounts as apportioned, into trust accounts authorized by the user, or into trust accounts mandated by the administrator (in the above example, the employer). In addition, the systems and methods may allow for the receipt of cash contributions or other direct transfers from a participant. For example, a participant may deposit money online using an electronic transfer from a bank account arranged by the participant to do so. Or, the participant may make cash deposits using an automated teller machine (ATM) that interfaces with the herein disclosed systems and methods, such as through an intermediary bank or the like.

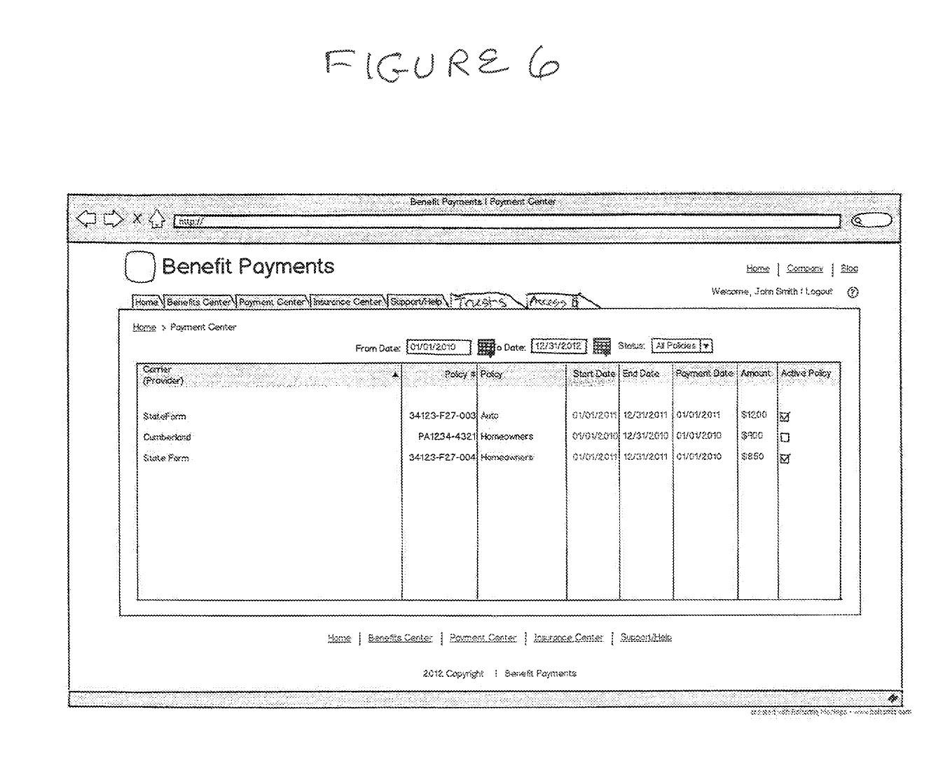

FIG. 6 is a screen shot illustrating aspects of the herein disclosed invention.

As illustrated, the vault account holder may securely enter an account, such as via a log in. The vault account may have therein information associated with a user, such as employment information, bank account and credit card information, payee information, trust account information, and the like. Also included in the information associated with the user's account may be API-related information, such as for third party sites to which payments are to be made, and third party security information, such as log-ins to third party sites at which ETFs are to be executed, payments are to be made, and the like.

In the example of FIG. 6, the vault account holder may log in to the secure vault. Upon log in the user may have access to, by way of non-limiting example, a home area, whereat the use may modify the user's information; an accessible monies area, whereat a user may add new accessible money accounts and/or apportion incoming monies to existing accounts; a payment center, whereat a user may set up automated or make manual payments, and/or apportion payments as between accessible monies; a benefits center, whereat a user may monitor available health care and other benefits, benefit payments, benefit providers, benefit administrators, and the like; an insurance center, whereat a user may interact with aspects of the insurer(s) provided as part of the benefits; and a help area, whereat a user may access help information, such as a phone number, email or real time help chat window. In the particular illustrated GUI, the user has accessed the payment center, and a sub menu regarding insurance payments, and is viewing policy particulars and payment history for different insurance companies.

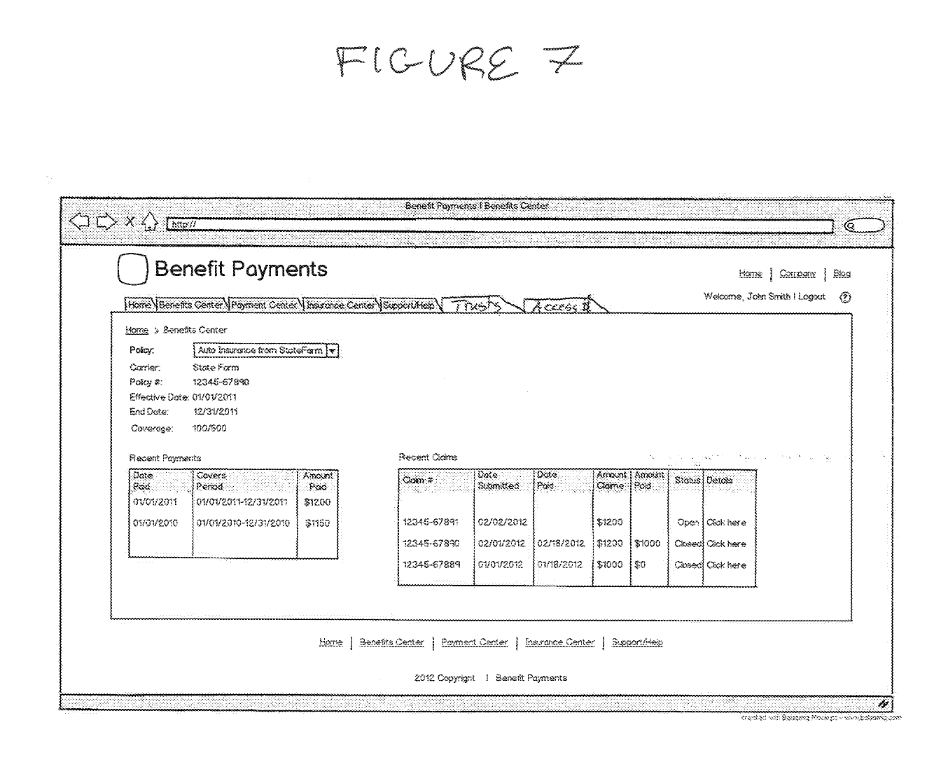

FIG. 7 is an additional illustration of the GUI of the instant invention. As illustrated, the benefits center may allow for “drill down” into particular benefits and benefit providers. The examples of FIGS. 6 and 7 further illustrate that a user may have a series of tabs, drop downs, tree menus, or the like, from which the user may access or indicate any of a variety of information. The user may further be provided with the capability to drill down after selection of areas under the tabs, file menus, tree menus, drop downs, or the like, in order to access more detailed information regarding the higher hierarchical selections.

FIG. 8 is a block diagram of aspects of an exemplary embodiment of the herein disclosed systems and methods as the embodiment may relate to the PPACA. As mentioned, the PPACA (“Obamacare”, or “the Act”) is divided into ten titles containing a great many provisions to be phased in over a number of years. An exemplary healthcare benefits system 800 may include a legal requirements information database 805 to act as a central repository for information pertaining to the Act. Such information may include the text of and/or links to statutes, regulations, administrative rules, opinions, guidance, and the like, with regard to federal, state, and local levels. Database 805 may store and index the text of relevant administrative and Article III court proceedings with regard to the Act, and/or explanatory notes pertaining to the administration of programs and the like authorized by or existing under the Act. Such information may be made available to any number of interested parties, including the insured (whether employed or not), employers, insurance companies, insurance brokers, and financial institutions, for example.

System 800 may further be arranged to act as a central repository for information pertaining to insurance programs and benefits programs that exist under the Act. In embodiments, system 800 may include a database 810 containing such insurance programs and benefits information. For example, this database may contain information of insurance programs offered by various providers. It may also contain information of the benefits provided under insurance that is in force with regard to specific individual and/or group insured parties.

In addition, system 800 may include database 815 containing information of insured participants in programs under the Act. System 800 may be arranged to provide for the administration of an individual's healthcare account, and/or of a pooled account that provides for the healthcare needs of a plurality of associated individuals, such as members of a family. In embodiments, one or more healthcare related financial transaction functions may be provided in association with system 800, as will be described.

System 800 may also include database 820 containing information of employers participating in programs under the Act. System 800 may be arranged to provide for the administration of an company's healthcare-related programs and initiatives, with minimal involvement and consequent administrative burden being borne by the employer. In embodiments, system 800 may be in data communication with a participating employer's payroll system, for example, via an API. The system may thus handle some or all of the administration of insurance programs for the employer, including handling payroll deductions, insured benefit account setup and administration, and handling insurance premium and other payments and other transactional tasks. In addition, the system may provide documentation that may be required to demonstrate employer compliance with the requirements of the Act and/or arising therefrom.

System 800 also includes healthcare engine 825, which may include software defining procedures to be performed using data stored in the databases. Such procedures may include, for example, encrypting and decrypting data when it is written to or retrieved from a database, respectively. Thereby, data in databases is not stored in the clear, so that should unauthorized access to the databases occur, the data may be read only in an encrypted format, keeping it confidential. In addition, the healthcare engine may provide application programming interfaces (APIs), and the like, for interfacing with other computing system, including remote systems, as will be described.

System 800 may provide access to engine 825 and databases 805, 810, 815, and 820 via gateway 830, which may implement security measures to allow system access only by authorized parties. For example, in an embodiment the gateway may be accessible over the Internet, and may establish a secure communication session with the visitor, using secure sockets for example. Further, the gateway may present to a visitor a login screen that accepts login credentials from the visitor. The gateway may authorize the visitor using the login credentials, or deny access to the system if incorrect credentials are input by a user. Other or additional security mechanisms may be used to gain access to the system, and/or to information stored in databases, such as domain-based security structures and permissions, hard or soft encryption keys, certificating authorities, and the like.

System visitors may include, for example, insured individuals, businesses, and insurance companies, each of which may obtain access to information and program features that are appropriate to the specific authorized party. Other parties may also gain access to certain appropriate information and features of the system. In embodiments, insured individuals may access the system using an app on a smartphone 840, or an application installed on a personal computer 845. In either case, access may be gained using software developed for that purpose. Alternatively, access to the system may be provided via a web browser-based interface. System 800 may then include or be coupled to a web server (not shown).

The system may communicate with other systems, using application programming interfaces (APIs) for example. Thereby, system 800 may communicate with other systems, for example, to exchange information, enroll participants in insurance programs and/or obtain insurance, to execute financial transactions such as paying insurance premiums and bills for services received, etc. In FIG. 8, such external systems are represented by server 850 external to system 800, and is shown communicating with system 800 via gateway 830, although other arrangements may also be used.

In embodiments, system 800 may be arranged to communicate with various parties, for example, by establishing a real-time communications channel. Such a channel may include a video conference, a chat session, or the like, between the participant and a live representative. Such sessions may include providing guidance on system usage and the like, for example. Sessions may also involve representatives of service providers that interface with the system, using computers 855 for example. Alternatively or in addition, system 800 may provide for sending messages between parties, such as emails or texts, making automated telephone calls, or automatically generating and sending snail mail. Message text of such communications may be obtained from templates containing boilerplate language combined with fields populated using the recipient's information, for example. Such messages may include notices of upcoming, scheduled, and/or completed monetary transactions, sent both to the payor and the payee. Messages may also include informational notices, for example, regarding events pertaining to legal requirements. Messages may also pertain to new programs or features available to a participant, which may be due to a change in a participant's status for example. Messages may also pertain to things such as invitations, recommendations, advertisements, opportunities, and the like. Such messages may be contingent on an intended recipient having indicated a willingness to receive such messages.

In embodiments, system 800 may receive monies, for example, in the form of cash deposits or bank credits, from any appropriate source. As such, the system may receive payroll deductions, such as by interfacing via an API with a participant's employer's payroll department or provider. Further, the system may be arranged to receive government subsidies, such as via an API to a government facility, and may deposit the subsidies into the appropriate participant accounts. In addition, the system may be arranged to receive cash contributions or other direct transfers from a participant. For example, a participant may deposit money online using an electronic transfer from a bank account arranged by the participant to do so. Or, the participant may make cash deposits using an automated teller machine (ATM) that interfaces with the system, or through an intermediary bank or the like.

In embodiments, system 800 may also disburse monies, for example in the form of cash withdrawals from an ATM, or by electronic transfers of account credit, such as to pay health insurance premiums and other qualifying payments under the Act. In embodiments, system 800 may make an account beneficiary's funds accessible for appropriate use through a debit card, such as a Visa or Mastercard branded card. Such a card may be used like a credit card to pay for healthcare-related products and services, and/or may be usable at an automated teller machine (ATM) to effect a cash withdrawal. In embodiments, the system may interface, such as via an API, the Automated Clearing House (ACH). As noted, the ACH is an electronic network for financial transactions that processes large volumes of credit and debit transactions. ACH credit transfers may include accepting direct deposit of payroll monies. ACH direct debit transfers for the insured may include payments to vendors and the like, such as payments to insurance providers for insurance premiums, payments to healthcare service providers for services received, payments to pharmacies and medical supplies vendors for qualifying drugs and equipment, and the like.

In an embodiment, ACH transfers may also be applied to other types of payments. In such embodiment, Vault usage may be expanded in scope to provide for more than just healthcare-related transactions. For example, Vault credits may be deposited from any source, and may be applied to cost, such as the payment of a mortgage loan or other types of bills. In embodiments, the Vault may be arranged to keep separate accountings of healthcare-related and non-healthcare-related transactions.

Thus, the system may provide participants with a payroll deduction-like process that does not require any employer administration. The system may do so by providing an individualized Benefits Vault that is maintained on behalf of an individual participant independently of an employer, and even without regard for the participant's employment status. Thereby, benefit premium payments may be ongoing, and benefits may be continuously maintained, with no gap in coverage. For example, the system may be configured to make payments and fulfill other administrative requirements for an employee under an employer benefit program until employment is terminated, then to administer a so-called COBRA (Consolidated Omnibus Budget Reconciliation Act of 1985) benefits plan for the insured between jobs, and then at a new job to administer the employee's benefits under a new employer's benefits plan. System 800 may thus make it convenient for an employee to budget for and to make periodic (e.g., monthly) premium payments, and to modify healthcare coverage as needed or desired.

The system may also be arranged to receive and to direct into an insured's Vault any applicable government subsidies. The subsidies may be received via an API to a government funding source, such as a computing environment of the Department of Health and Human Services (HHS) for example. Because subsidies are determined based on an insured's income, if an insured does not calculate income properly and understates income, and thereby receives a larger subsidy then he/she is actually qualified for, the insured may be obliged to return the overpayment to the government. In an exemplary operation, system 800 may then act as a compliance mechanism, effecting repayment from the Vault and/or other appropriate sources of funds, and documenting compliance with all program requirements and fulfillment of all participant obligations. The system may handle such tasks with little or no direct involvement by the insured. The system may also be arranged to communicate with the insured in such events, for example, by sending a template containing boilerplate text with fields populated with participant information, via an email, text, automated telephone call, or automatically generated snail mail.

In embodiments, system 800 may be arranged enable contributory benefits to be paid through the Vault, eliminating employer administration and giving employees more choice in healthcare products, service providers, and/or insurance carriers, including products offered through the employer, a vendor, a health information exchange (HIX), or other party. The herein disclosed systems and methods may enable participants to simplify payment of all insurance premiums via payroll deduction, whether or not the insurance was obtained through work, providing the ability to budget on a per pay basis and remit premiums to carriers automatically.

In embodiments, system 800 may be arranged to enable a participant to obtain quotes on any available insurance policy or other healthcare-related product or service. Such quotes may be provided upon request at the participant's convenience by interfacing with quoting platforms used by vendors and/or brokers, such as an HIX. Thereby, information stored in the system that is needed to provide the requested quote may be accessed, filtered, and provided in accordance with applicable privacy regulations (e.g., HIPAA) to insurance providers, such as directly to a carrier or through a broker, to obtain pricing.

In embodiments, system 800 may be arranged to maintain a library of forms for various uses by participants, such as uniform application forms for initiating coverage online, submitting claims, or authorizing health coverage modifications, for example. Such online forms may be printed by the applicant for their records. The forms may incorporate links, scripts, and/or other embedded technology useful to enroll participants into an exchange-based health plan, such as over the web or by smartphone. The herein disclosed systems and methods may also be arranged to calculate contributions to healthcare costs, whether by the insured, the employer, or the government.

In embodiments, system 800 may provide an online interface for use by an insured to submit a claim for a Health Reimbursement Account (HRA) reimbursement. The system may allow for supplemental insurance payments directly from carrier, such as for critical illness, accident, hospital indemnity, and disability. In embodiments, the system may include forms needed for relevant carriers, instructions for filing claims, and the like. Thereby, multiple insurance products from multiple carriers may be used to pay a healthcare product or service provider, as well as using funds from multiple sources. Information of all transactions may be stored for tracking, reconciliation, and documentation.

In embodiments, system 800 may be arranged to interface with Personal Financial Management (PFM) programs. Such programs may be installed on a local computing device of the participant, such as Quickbooks for example. Such programs may also be hosted on remote host servers, such as Quickbooks Online, for example. Such an arrangement may thus include concurrent data connections between computing environments of the system, the insured, and the remote program host.

Thus, system 800 may provide a unified platform in which all information pertaining to benefits and associated policies can be stored and shared, as needed or upon demand, thereby providing a single point of access for all benefits. Information may be obtained and/or provided as appropriate by an insured participant, a sponsoring company, an insurance provider, a healthcare service or product provider, or other appropriate party. To do so, the system may automatically access information in its own databases, as well as information stored remotely in another source, such as via an API. As such, the system may provide, via a single sign-on, access to any relevant information, disposed in any accessible data store, at any relevant time.

In embodiments, system 800 may be arranged to provide offers and opportunities pertaining to healthcare to employees based on their status, including based on their previous employment history, current employment status, job change, family change, etc. Mechanisms may be incorporated that provide for various calculations using any of a variety of calculation methods, for example, calculators that provide recommendations for insurance coverage and/or determine or estimate insurance premiums.

In an embodiment, access to the system may be provided at no cost to the insured. In such embodiment, fees for using the system may be charged in whole or in part to the insured's employer. Fees may also be charged to health insurance providers and other product and service providers. Benefits to such providers may include, for example, offering access to a consenting participant's information, such as to provide leads for marketing efforts or the like. In an embodiment, limited-feature base system functionality may be provided at no cost to an insured, with additional functionality offered for fees that may be paid by the insured, for example, by a charge to the insured's account. Or, such enhanced functionality may be allocated among parties in the form of a benefit to the insured. For example, costs for fee-based services may be borne by an employer as an employee benefit. Fees for a prospective customer may alternatively be borne by a product or service provider to encourage learning about their offerings. In an embodiment, prospective customers may receive an incentive, such as a free or reduced-cost trial period to use the system, and/or to try other associated providers' offerings. In an embodiment, a credit may be provided by an employer or a provider to an insured's Vault in appropriate cases.

Fees associated with using the system may include, without limitation, any of the following, individually or in combination. So-called Per Member Per Month (PMPM) fees may be charged. For example, fees in the range of $5.00 to $10.00 PMPM may be charged. As noted previously, such fees may be paid by an employer for its employees. In addition, in an embodiment, one or more set up fees may be charged, for example, for setting up an initial account, and/or for select functionality that may be selected by the insured or by his/her employer, for example.

Further, insurance carriers may be charged administration and/or billing fees on a PMPM basis. Fees may be in accordance with a fee structure based on volume, such as by the number of policies provided, and/or the value of the policies, and the like. For example, a structure may provide for high volume distributors fees that include a low PMPM fee, and higher PMPM fees for less volume. Such a structure may include a variety of levels, based on a variety of factors. Alternatively or in addition, annual fees may be charged for services rather than PMPM fees, which may also be based on a variety of factors.

Other sourced of fees generated by the system for the system operator may include Visa/Mastercard interchange fees in connection with the use of branded Vault cards.

Fees may also be collected from providers that use or benefit from the use of the system. Such providers may include providers of services accessed by participants through the APIs of the system hereinbefore described. Further, fees may be charged to employers for worksite account administration, enrollment support, training, product placement, and the like. In addition, fees may be charged for services such as 401k rollovers and other appropriate financial products.

Because the herein disclosed systems and methods capture useful information from payroll, job status, healthcare usage, family status, etc., such information may be used in any permitted manner. Such usage may or may not be restricted to healthcare related products and services. For example, the single sign-on process may allow a participant to access, via API-based system interfaces, to online shopping services, online entertainment providers, and/or virtually any other online product or service for which there is a demand from participants. Such APIs may be developed in anticipation of, or in response to, such participant demand.

In embodiments, system 800 may provide the participant with the ability to “opt in” to an arrangement to share their own information, which would otherwise be maintained in confidence by the system. An opt in choice may be made available, for example, by presenting an insured an online mechanism that lists some or all of the information fields maintained by the system, with a check box or the like to indicate which fields the participant is willing to share. The mechanism may also present screens containing mechanisms, such as text boxes, drop down lists, and the like, that allow the participant to specify who may be granted access to information, and which information may be accessed by the specified party(s). By opting in, the participant may receive information from vendors, and/or may participant in marketing programs or the like.

In embodiments, system 800 may be arranged to obtain funds from a participant's own other sources, such as from a bank account, on a schedule that may be set by the participant. The obtained funds may then be set aside and held in the participant's Vault until a payment is due. The payment may be applied to a particular bill that is coming due that is selected by the participant. Or, payments may be applied to bills that come due without more specific instructions from the participant. In embodiments, if there is a time lag between when monies are received into the Vault and when payments are made, the Vault operator may manage the Vaulted funds in a manner that accrues interest. If so, the Vault operator may keep the interest as profit, or may share the interest with the participant in any proportion, or may add the interest to the Vault for the benefit of the participant, whichever is desired by the operator or allowed by regulation.

Thus, a participant's Vault may be arranged to enable the participant to aggregate all insurance premiums and other benefit transactions, whether the benefits were obtained through work or personally, allowing the participant to budget on a “per pay” basis and remit premiums to carriers more easily and conveniently than otherwise.

In embodiments, system 800 may provide links to other systems to create a seamless user experience. For example, a particular system installation may not provide directly for the ability to keep track of medical bills. However, if that ability is available from a vendor, the system may interface with the vendor through an API, for example, to provide a user with a seamless user experience to keep track of medical bills.

FIG. 9A is a flowchart of a method that may be implemented on behalf of a participating insured using the hereinbefore described system. A prospective insurance plan participant may begin using the system by registering with the system 910A. Registration and other registrant processes may involve submitting information, which may be accomplished by way of submitting paper forms via mail or fax, and/or by filling out and submitting forms online, for example. In particular, the registration processes may comprise submitting appropriate registrant information, establishing security credentials, and setting up a personal Benefits Vault. The participant may also provide authorization, such as by submitting a form, to direct money from a payroll or other compensation system into the Benefits Vault. In an embodiment, the Vault may comprise an FDIC insured account, and the direct deposit arrangement may include submitting an E Signature Direct Deposit (DD) form, for example, emailed to a payroll contact at the employer or the payroll service provider, if any.

The participant may then select and set up healthcare measures, 420A. For example, in an embodiment system 800 may determine, based in part on information submitted by the participant, as well as information from the participant's employer, from brokers and/or carriers, etc., and in accordance with legal requirements, which of a variety of available programs the participant may qualify for. To do so, the system may access information stored in one or more local or remote databases, apply rules and filters, execute one or more algorithms to make recommendations, and present tools such as calculators and the like to the participant. The participant may use these mechanisms to identify and research available healthcare options, select one or more desired healthcare measures such as insurance policies, healthcare providers, pharmacies, programs and the like, and use the system to enroll therein and/or establish appropriate relationships. Such enrollment may draw from information already submitted by the applicant. If the applicant is identified as an employee of an employer that has itself registered with the system, any needed employer information may be retrieved from the appropriate database rather than being entered by the applicant. The applicant may then provide any remaining requisite information to enroll in the selected programs.

Subsequently, system 800 may set up financial arrangements needed to realize the selected healthcare measures, 930A. Such arrangements may include, for example, retrieving the proper forms, populating them with already available information, prompting the participant for any other needed information and providing any tools that may be useful to do so. The system may then set up the financial arrangements authorized by the participant. For example, such arrangements may include payroll deductions, electronic funds transfers, charges to credit cards or other credit facilities, and the like. The arrangements may entail setting up interfaces with other systems, such as via one or more APIs which may be developed and implemented for that purpose. The other systems may include, for example, an employer's payroll system or payroll provider's system or the like. In addition, the system may similarly provide for the participant's Vault to be the destination in which the employer may deposit their contribution to the cost of healthcare on behalf of the participant. Further, the system may similarly provide for the participant's Vault to be the destination in which the government may deposit their subsidy for the cost of healthcare on behalf of the participant. Such transactions may use already available mechanisms to implement electronic financial transactions.

In an embodiment, the participant may set up arrangements for the case wherein the combined total payroll deducted amount, the employer contribution, and any government subsidy total less than the premium or other costs due. Such arrangements may include, for example, the participant providing further information regarding sources of additional funds, such as an account to debit via an electronic funds transfer (EFT), a credit card to charge, or the like. In an embodiment, credit financing may be arranged. Such credit financing may include online prompts for the applicant to follow to authorize an additional payroll deduction, a credit worthiness query, and/or information needed to interface with a bank or other financial institution that may provide the credit financing.

The system may also provide for the participant to set up bill payment in connection with specific policies, such as to pay insurance carriers. In an embodiment, the system may provide online prompts for the applicant to follow to do so. The system may also be used to set up and/or interface with an existing health reimbursement account (HRA). In an embodiment, the system may provide an adjudication process to obtain an employer contribution, if any, for a healthcare cost incurred, without violating HIPAA confidentiality requirements.

Finally, system 800 may execute the transactions that were set up, 940A. This may include directing payroll deductions, contributions, subsidies, and other monies, into the participants Vault. Also included may be automated payment by electronic transfers of regularly scheduled insurance premiums and other appropriate payments. The system may also provide online forms, prompts, tools, guidance and prompts, if needed by the participant to submit claims, obtain healthcare services and/or products, and the like. In addition, the system stores all transaction information and may provide documentation pertaining thereto as desired. Such documentation may include online access by the participant to full descriptions of all monies received, disbursements made, upcoming event schedules, etc.

Similarly, FIG. 9B is a flowchart of a method that may be implemented on behalf of a participating employer company using the hereinbefore described system. A company participant may begin using the system by registering with the system 910B. Registration and other processes may involve submitting information, which may be accomplished by way of submitting paper forms and/or by filling out and submitting forms online, for example. The employer registration processes may comprise submitting appropriate company information, establishing security credentials, and setting up interfaces with the system. Such interfaces may include providing to the system 800 operator data fields and format for use in selecting or developing an appropriate API to interface the employer system(s) with system 800. The employer may also provide authorization, such as by submitting a form, to direct money from a payroll or other compensation system into a plurality of employees' Benefits Vaults.

The employer may then select and set up healthcare measures, 920B. For example, in an embodiment system 800 may make recommendations, based in part on information submitted by the employer, information of common practices, and in accordance with legal requirements, regarding which of a variety of available contributions to employee healthcare may be most appropriate for the employer. To do so, the system may access information stored in one or more local or remote databases, apply rules and filters, execute one or more algorithms to make recommendations, and present tools such as calculators and the like to the employer. The employer may then select one or more healthcare measures to contribute, such as monetary contributions into the employee Vaults, prepayment of certain costs such as healthclub memberships, fees for the insureds' use of system 800, etc. The employer may then use the system to establish appropriate interfaces, payments, and relationships.

The employer may use system 800 to set up financial arrangements needed to realize the selected healthcare measures, 930B. Such arrangements may include, for example, the system retrieving the proper forms, populating them with already available information, prompting the employer for any other needed information and providing any tools that may be useful to do so. For example, such arrangements may include payroll deductions, electronic funds transfers, charges to credit facilities, and the like. The arrangements may entail setting up interfaces with employer systems, such as via one or more APIs which may be developed and implemented for that purpose. The employer's systems may include a payroll system or payroll provider's system or the like.

Finally, system 800 may execute the transactions that were set up, 940B. This may include directing payroll deductions and employer contributions into the participants' Vaults. As before, the system stores all transaction information and may provide documentation pertaining thereto as desired. Such documentation may include online access by the employer to full descriptions of all monies paid, disbursements made, upcoming event schedules, etc. In addition, system 800 may aggregate funds on behalf of all participating employees of the employer and provide reports showing monies aggregated and applied for each employee.

Further, the system may provide similar information to insurance carriers that provide insurance coverage for employees in a format the insurance carrier needs, for processing by the carrier.

In embodiments, system 800 may provide on a regular schedule or in response to prompts any documentation that may be needed to demonstrate compliance with all legal requirements. Such documentation may be provided, for example, to the employer, to a service provider, or to an insurance carrier, for example.

In sum, the herein disclosed systems and methods provide a non-employer driven, participant managed portable electronic solution for insurance benefit plan maintenance and payments. Thereby, employers may be relieved of responsibility for the large majority of tasks, responsibilities, and potential liabilities associated with the benefits workstream, including payroll deductions, accounting tasks, premium payments, etc. Further, the systems and methods provide for insurance agents, brokers, and underwriters to communicate new alternatives to system participants. The system also enables participants to set up and modify insurance arrangements at their convenience.

In addition, the herein disclosed systems and methods provide for easy communication between various parties that access the system. For example, messages and/or real-time communication channels may permit communications between a company and an insurance provider, between an underwriter and brokers and agents, and between any of the above and consumers.

Further, the herein disclosed systems and methods establish a portable Benefits Vault whereby a participant may use the same Vault in connection with any employer and/or any participating financial institution to provide for continuity of healthcare coverage. Carriers and other insurance benefit providers may also be provided with ongoing, standardized electronic payments for premium continuity. Thus, consumers may enjoy continuous services through changes in status, between jobs, in transition, at a new employer, while un-employed or working full or part time, even without a conventional bank account.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

What is claimed is:

1. A computer-implemented system for managing insureds' benefits information, comprising:
a server computer containing:
a computing processor;
a network interface device in data communication with the processor and operative to communicatively couple the processor to a tangible data communication network; and
a non-transitory computer-readable data storage device in data communication with the processor having stored thereon computer readable instructions which, when executed on the processor, cause the computer to implement:
a database (“benefits vault”) operative to store data of at least one insured party, at least one benefit choice of the insured, at least one financial contribution to the benefits vault, and at least one restriction on the use of the financial contribution;
a rules engine coupled to the benefits vault and operative to associate the benefit choice with the insured in accordance with predetermined criteria;
a remote benefits engine operative to access at least one third party resource on a network to implement the benefit choice; and
a reporting engine operative to provide confirmation of said implementation.

2. A method for managing insureds' benefits information, comprising:
storing data of at least one insured party, at least one benefit choice of the insured, at least one financial contribution to a debit account of the insured, and at least one restriction on the use of the financial contribution;
associating the benefit choice with the insured in accordance with predetermined criteria;
accessing at least one third party resource on a network to implement the benefit choice; and
providing confirmation of said implementation.
